(19) United States
(12) Patent Application Publication
(10) Pub. No.: US 2007/0007117 A1
(43) Pub. Date: Jan. 11, 2007

(54) Switch

(76) Inventor: Eiji Kodoh, Fukui (JP)

Correspondence Address: WENDEROTH, LIND & PONACK L.L.P., 2033 K. STREET, NW, SUITE 800, WASHINGTON, DC, 20006, US

(21) Appl. No.: 11/476,671

(22) Filed: Jun. 29, 2006

(30) Foreign Application Priority Data
Jul. 6, 2005 (JP) 2005-197145

(51) Int. Cl. H01H 21/00

(52) U.S. Cl. 200/293

(57) ABSTRACT

The switch disclosed comprises bosses, protruding outward from side surfaces of the case, located below the supports extending downward to catch the side surfaces of the case. Even if the switches collide with each other or with tools or the like occasionally, the bosses prevent the supports of cover from being put an outward force and thereby prevent the cover from coming off from the case. The structure can provide the switch with a reliable operationality.

### TECHNICAL FIELD

The present invention relates to a switch used to operate electronic equipment.

### BACKGROUND ART

With the advance in recent compact and low-profile design in various kinds of electronic equipment such as TV set, video recorder, air conditioner or the like, the switch used for the equipment is required to be also compact and low-profile and that can operate reliably.

Such a conventional switch is described with reference to FIGS. 4 and 5. FIG. 4 shows a perspective view of the conventional switch and FIG. 5 shows a cross-sectional view of the same. In FIGS. 4 and 5, generally box shaped case 1 is formed from an insulation resin and is open-topped. Fixed contact 2 is formed of conductive thin metal plate. A plurality of fixed contacts 2 are implanted secured on internal surfaces of case 1, with terminal pins 2A protruding downward from the bottom surface of case 1.

Operating body 3 is formed from an insulation resin and is housed in case 1 movably vertically. Head 3A protruding upward is formed on top of operating body 3.

Movable contact 4 formed of elastic thin metal plate bent into open sided square is mounted on operating body 3. Movable contact 4 touches fixed contact 2 elastically to form a switch assembly.

Cover 5 is formed from an insulation resin and spring 6 has a coiled form. Cover 5 covers an opening in the top surface of case 1 and spring 6 is mounted between the bottom end of operating body 3 and the internal bottom surface of case 1 while being compressed slightly. Spring 6 biases operating body 3 with head 3A protruding upward out of the opening in the top surface of case 1 upward.

Cover 5 is provided with a pair of supports 5A extending downward. Land 1A disposed on a side surface of case 1 catches groove 5B of support 5A to fix cover 5 on case 1.

A certain number of switches thus formed are stored or transported in packed in a bag and then head 3A is provided with a push-button before the switch is built into an operation panel of electronic equipment. Terminal pin 2A of fixed contact 2 is connected electrically to a circuit of electronic equipment by soldering or the like.

When head 3A provided with push-button or the like is pressed in the above configuration, operating body 3 moves downward while compressing spring 6. With the movement, fixed contacts 2 to which movable contact 4 touches elastically are switched over, performing an electrical switching.

When head 3A is released from the pressing force, operating body 3 returns upward to the original position by the restoring force of spring 6.

Japanese Patent Unexamined Publication No. 2004-273199 is known as an example of the Information Disclosure Statement (IDS) for the present invention.

However, when stored or transported in packed in bags or built into equipment, the aforementioned conventional switches have collided with each other or with tools or the like occasionally, hitting support 5A of cover 5. Upon being put a force on support 5A outward, groove 5B would come off from land 1A provided on side surface of case 1, causing problems for the switch to break down or to operate unreliably.

### SUMMARY OF THE INVENTION

The present invention aims at providing a switch capable of reliable operation with a simple structure to solve the conventional problems. The switch disclosed in the present invention comprises bosses protruding outward located below the supports extending downward to catch the side surfaces of the case. Even if the switches collide with each other or with tools or the like occasionally, the bosses prevent the supports of cover from being put an outward force and thereby the cover from coming off from the case to provide the switch with a reliable operationality.

The boss can protrude outward higher than the support. This will prevent the cover from coming off more reliably.

### BRIEF DESCRIPTION OF THE DRAWINGS

FIG. 1 shows a perspective view of a switch used in the preferred embodiment of the present invention.

FIG. 2 shows a cross-sectional view of the switch used in the preferred embodiment of the present invention.

FIG. 3 shows a perspective view of the other switch model used in the preferred embodiment of the present invention.

FIG. 4 shows a perspective view of a conventional switch.

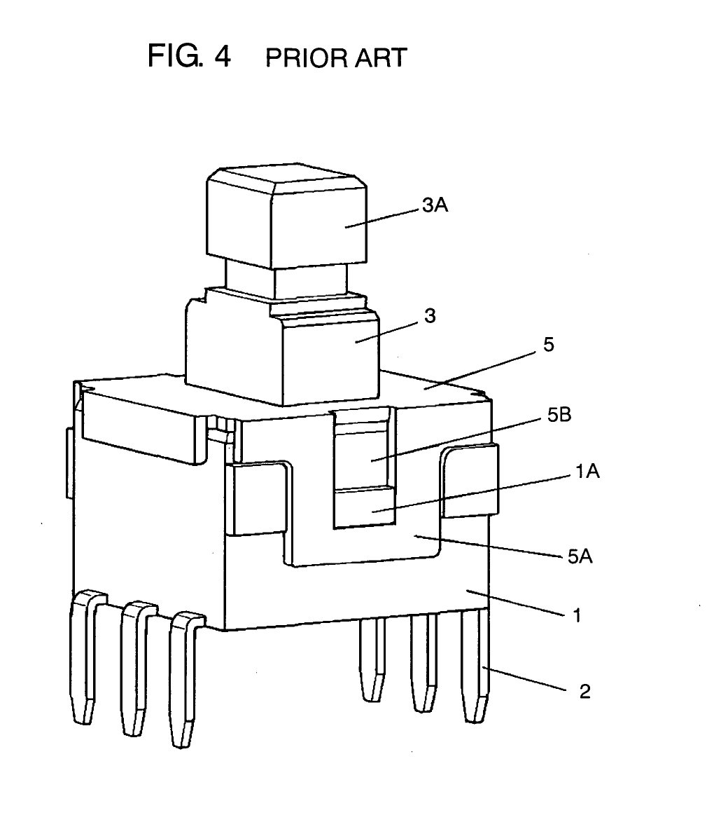

FIG. 5 shows a cross-sectional view of the conventional switch.

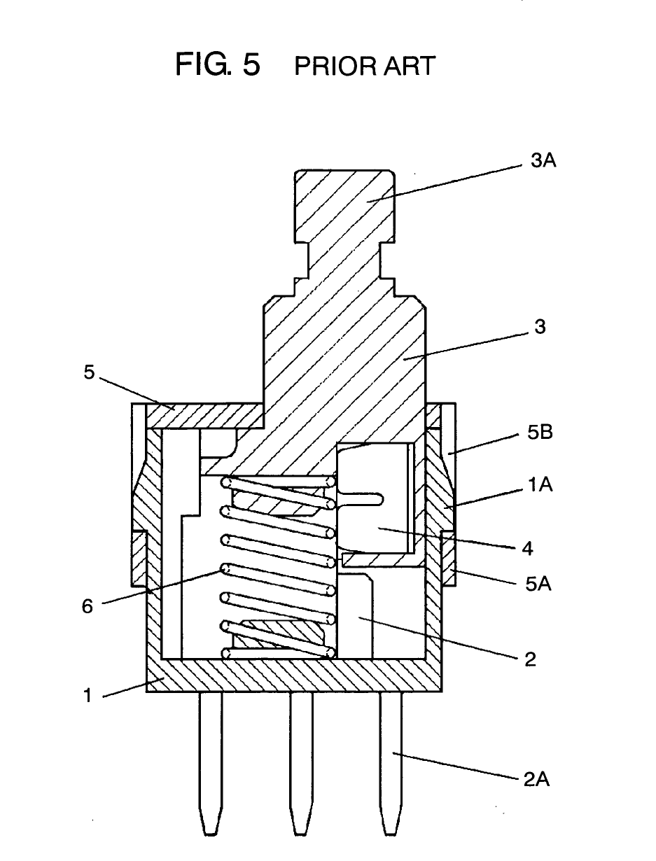

### DETAILED DESCRIPTION OF THE INVENTION

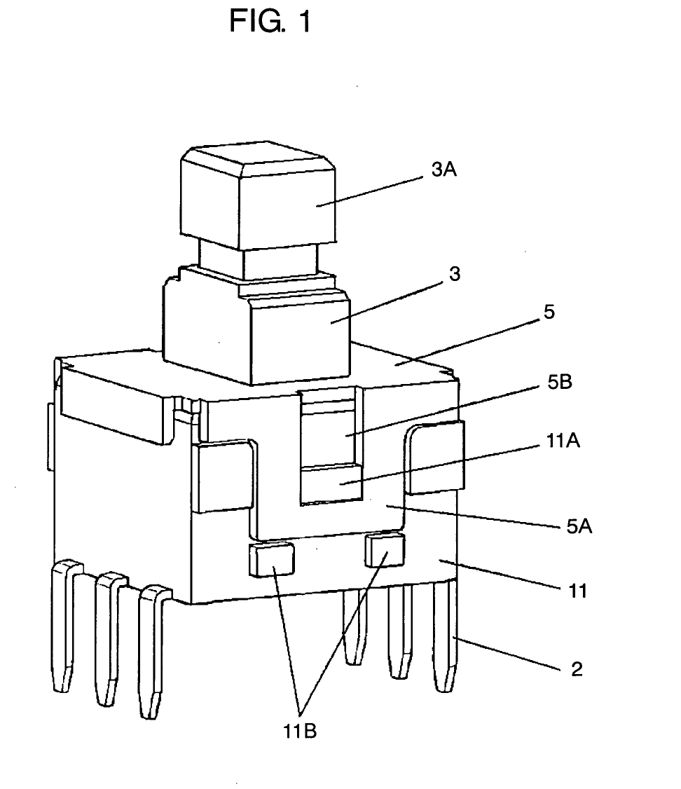

The preferred embodiment of this invention is described with reference to FIGS. 1 to 3. The similar configurations described in the background art have the same reference marks, and the detailed description thereof is omitted.

### Preferred Embodiment

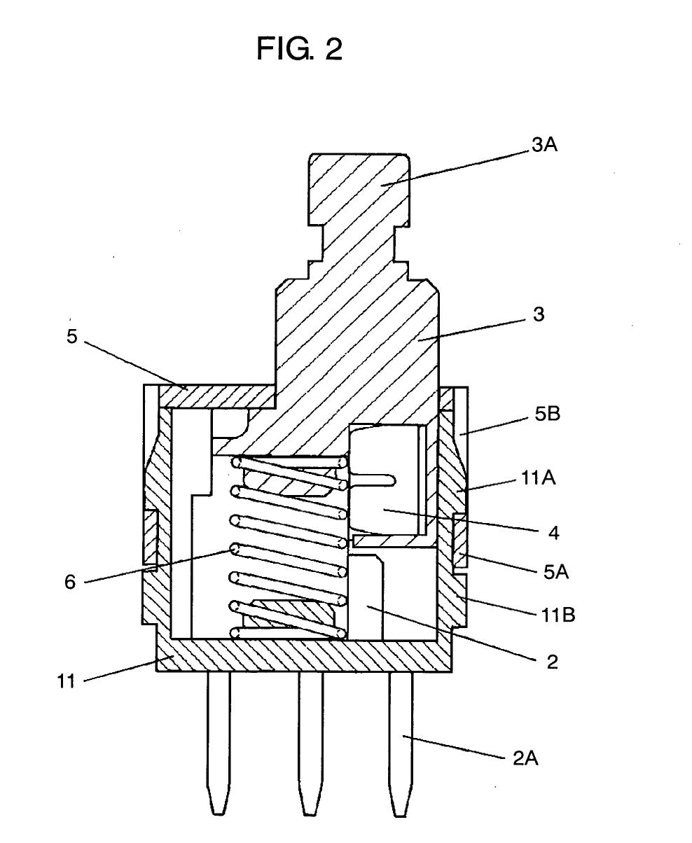

FIG. 1 shows a perspective view of the switch used in the preferred embodiment of the present invention, and FIG. 2 shows a cross-sectional view of the same. In FIGS. 1 and 2, open-topped box shaped case 1 is formed from an insulation resin such as polyphenylene sulfide, polybutylene terephthalate or the like. Fixed contact 2 is formed of thin conductive metal plate such as copper alloy or the like.

A plurality of fixed contacts 2 are implanted secured on internal surface of case 11, with terminal pins 2A protruding downward from the bottom surface of case 11.

Operating body 3 is formed from an insulation resin such as polyoxymethylene, polybutylene terephthalate or the like and is housed in case 11 movably vertically. Head 3A is formed protruding upward on the top of operating body 3.

Movable contact 4 is formed of elastic thin metal plate such as copper alloy bent into open-sided-square and is mounted on operating body 3. Movable contact 4 touches fixed contact 2 elastically to form a switch assembly.

Cover 5 is formed from an insulation resin such as polyoxymethylene, and spring 6 has a coiled form. Cover 5 covers the opening in top surface of case 1 and spring 6 is mounted between the bottom end of operating body 3 and the bottom of internal surface of case 1 being compressed slightly. Spring 6 biases operating body 3 with head 3A protruding upward out of the opening in the top surface of case 1 upward. Cover 5 is provided with a pair of supports 5A extending downward. Lands 11A on both sides of case 1 catch grooves 5B of supports 5A to fix cover 5 on case 11. A plurality of bosses 11B are formed on both sides of case 11 below support 5A.

A certain number of switches thus formed are stored or transported in packed in a bag and then head 3A of the switch is provided with a push-button before the switch is built into an operation panel of electronic equipment. Terminal pin 2A of fixed contact 2 is connected to a circuit of electronic equipment electrically by soldering or the like.

The switch disclosed in the present invention has the structure such that upon stored or transported in packed in a bag or built into equipment if the switches would collide with each other or with tools or the like occasionally for instance when collide with something like a thin plate from below they can not hit the bottom edge of support 5A of case 11 but will hit only bosses 11B formed on side surfaces of case 11 below support 5A.

That is, the configuration is such that if the switch collides with each other or with tools or the like they would hit bosses 11B, causing no force on supports 5A to open outward and eventually to come grooves 5B off from lands 11A provided on the side surfaces of case 11. The configuration, therefore, will never cause any breakdown or unreliable operation for the switch.

When pressing the push-button or the like on head 3A in the configuration, operating body 3 moves downward while compressing spring 6. The operation switches over fixed contact 2 to which movable contact 4 touches elastically, thus performing electrical switching operation. When head 3A is released from the pressing force, operating body 3 returns upward to the original position by the restoring force of spring 6.

As described above in the preferred embodiment, bosses 11B are formed outward on both side surfaces of case 11 below supports 5A which extend downward from cover 5 to catch side surfaces of case 11. Bosses 11B can prevent supports 5A of cover 5 from putting outward forces if the switches collide with each other or with tools or the like. The present invention, therefore, can provide the switch that can prevent cover 5 from coming off from case 11 to operate reliably. Moreover, boss 11B protruded outward further from support 5A would prevent cover 5 from coming off from case 11 more reliably.

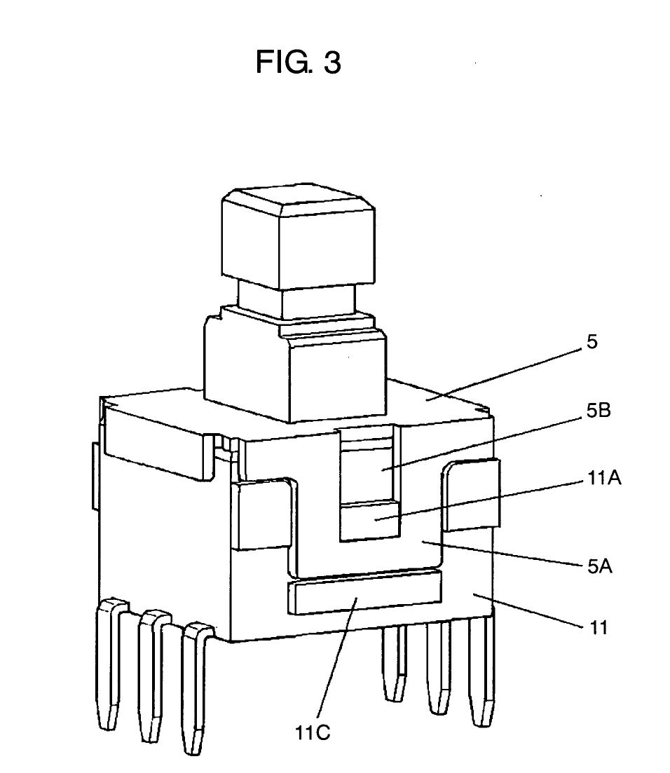

FIG. 3 shows a perspective view of the other switch model used in the preferred embodiment of the present invention. In FIG. 3, boss 11C formed along the entire width of the bottom edge of support 5A would prevent cover 5 from coming off more reliably.

The so-called push-button switch is used as an example in the above description that operates by pressing operating body 3 housed in case 11 being biased to move vertically by spring 6. However, the embodiment of the present invention can be available in the other kinds of switches of different operating ways such as slide-switch, seesaw-switch or the like.

The present invention can provide the switch with a simple structure and a reliable operationality and is useful for use in various kinds of electronic equipment.

What is claimed is:

1. A switch comprising:
an open-topped box shaped case;
an operating body housed in the case movably;
a switch assembly for electrical switching according to movements of the operating body; and
a cover to cover an opening of the case, with supports extending downward along the case to catch side surfaces of the case, wherein bosses protruding outward are provided on the side surfaces of the case below the supports.

2. The switch of claim 1, wherein the boss protrudes outward higher than the support.
